(19) United States
(12) Patent Application Publication
(10) Pub. No.: US 2009/0169003 A1
(43) Pub. Date: Jul. 2, 2009

(54) BROADCAST PROCESSING APPARATUS AND METHOD THEREOF

(75) Inventor: Je-hun SUNG, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/125,436

(22) Filed: May 22, 2008

(30) Foreign Application Priority Data
Dec. 27, 2007 (KR) 2007-139033

(51) Int. Cl. H04N 7/167; H04L 9/08; H04L 9/14

(52) U.S. Cl. 380/239; 380/279; 380/45

(57) ABSTRACT

A broadcast processing apparatus and method thereof, the broadcast processing apparatus including: a decryptor to decrypt a broadcast encrypted by a cable card using a decryption key; and a controller to control the broadcast decrypted by the decryptor to be re-encrypted and stored. Therefore, it is possible to preserve the security of broadcast content and it is easier to manage the security of broadcast content, without generating a separate encryption key.

### CROSS-REFERENCE TO RELATED APPLICATION

This application claims the benefit of Korean Application No. 2007-139033, filed Dec. 27, 2007 in the Korean Intellectual Property Office, the disclosure of which is incorporated herein by reference.

### BACKGROUND OF THE INVENTION

1. Field of the Invention

Aspects of the present invention relate to a broadcast processing apparatus and a broadcast processing method thereof, and more particularly, to an apparatus and a method for processing broadcasts received using a cable card.

2. Description of the Related Art

Broadcast processing apparatuses, such as set-top boxes (STBs) or digital televisions (DTVs), receive broadcasts from broadcast stations, and appropriately process the received broadcasts to be displayed on displays. In particular, cable broadcast processing apparatuses (such as cable STBs, open-cable DTVs, and cable-ready DTVs) receive cable broadcasts and perform signal processing on the received broadcasts. Accordingly, TVs that are connected to cable STBs, open-cable DTVs, or cable-ready DTVs provide users with the processed broadcasts through cables.

Such broadcast processing apparatuses include cable cards provided by cable broadcast providers so that users can normally view charged channels. That is, only an authorized user can use specific services among services provided through charged channels. To authorize a user, cable cards are connected to STBs or DTVs to decrypt encrypted broadcasts.

Cable cards serve not only to decrypt encrypted broadcasts, but additionally re-encrypt the decrypted broadcasts and transfer the encrypted broadcasts to DTVs. Re-encryption prevents broadcasts from being illegally redistributed by users or a third party. Broadcast signals transmitted to broadcast processing apparatuses are stored in hard disc drives (HDDs) of DTVs using decrypting and encrypting processes.

However, even after broadcasts are stored in HDDs, it may be possible to illegally copy broadcasts by separating HDDs from DTVs or STBs. Accordingly, unauthorized users are able to view charged channels illegally, and thus there is a need for methods of preventing broadcasts from being illegally redistributed.

### SUMMARY OF THE INVENTION

Aspects of the present invention relate to a broadcast processing apparatus in which a broadcast encrypted variably according to broadcast segments by a cable card and received from the cable card is stored in order to prevent the broadcast from being illegally copied by a user not authorized to view the broadcast, and a method of processing a broadcast.

According to an aspect of the present invention, there is provided a broadcast processing apparatus receiving a broadcast encrypted by a cable card, the apparatus including: a decryptor to decrypt the broadcast encrypted by the cable card; an encryptor to re-encrypt the broadcast decrypted by the decryptor using one or more re-encryption keys; a storage unit to store the broadcast re-encrypted by the encryptor; and a controller to generate the one or more re-encryption keys and to transmit the generated one or more re-encryption keys to the encryptor.

The controller may update the one or more re-encryption keys at regular intervals and control the one or more re-encryption keys to be varied.

The controller may control information regarding the broadcast and/or a segment thereof re-encrypted using the one or more re-encryption keys and information regarding the one or more re-encryption keys to be stored.

The decryptor may re-decrypt the re-encrypted broadcast stored in the storage unit using one or more re-decryption keys, and the controller may variably generate the one or more re-decryption keys and transmit the generated one or more re-decryption keys to the decryptor.

The controller may variably generate the one or more re-decryption keys according to the broadcast and/or a segment thereof using the information regarding the broadcast segment re-encrypted using the one or more re-encryption keys and the information regarding the one or more re-encryption keys.

The one or more re-encryption keys may correspond one or more encryption keys used by the cable card to encrypt the broadcast.

The one or more encryption keys and the one or more re-encryption keys may implement copy protection (CP) encryption.

The broadcast may be a cable broadcast.

According to another aspect of the present invention, there is provided a method of processing a broadcast encrypted by a cable card, the method including: decrypting the broadcast encrypted by the cable card; generating one or more re-encryption keys; re-encrypting the decrypted broadcast using the generated one or more re-encryption keys; and storing the re-encrypted broadcast.

The generating of the one or more re-encryption keys may include updating the one or more re-encryption keys at regular intervals and variably generating the one or more re-encryption keys.

The method may further include storing information regarding the broadcast and/or a segment thereof re-encrypted using the one or more re-encryption keys and information regarding the one or more re-encryption keys.

The method may further include variably generating one or more re-decryption keys; and re-decrypting the re-encrypted broadcast using the generated one or more re-decryption keys.

The generating of the one or more re-decryption keys may include variably generating the one or more re-decryption keys according to the broadcast segment using the information regarding the broadcast segment re-encrypted using the one or more re-encryption keys and the information regarding the one or more re-encryption keys.

The one or more re-encryption keys may correspond to one or more encryption keys used by the cable card to encrypt the broadcast.

The one or more encryption keys and the one or more re-encryption keys may implement copy protection (CP) encryption.

The broadcast may be a cable broadcast.

According to yet another aspect of the present invention, there is provided a computer-readable recording medium encoded with the method of processing a broadcast.

According to still another aspect of the present invention, there is provided a broadcast processing system receiving a broadcast, the system including: a cable card to encrypt the broadcast using one or more encryption keys; and a broadcast processing apparatus including: a decryptor to decrypt the encrypted broadcast using one or more decryption keys, an encryptor to re-encrypt the broadcast decrypted by the decryptor using one or more re-encryption keys, and a storage unit to store the broadcast re-encrypted by the encryptor.

According to another aspect of the present invention, there is provided a method of processing a broadcast, the method including: encrypting the broadcast using one or more encryption keys in a cable card; transmitting the encrypting broadcast from the cable card to a broadcast storage apparatus; decrypting the encrypted broadcasting using one or more decryption keys in the broadcast storage apparatus; re-encrypting the decrypted broadcast using one or more re-encryption keys in the broadcast storage apparatus; and storing the re-encrypted broadcast in the broadcast storage apparatus.

According to yet another aspect of the present invention, there is provided a broadcast processing apparatus receiving an encrypted broadcast, the apparatus including: a decryptor to decrypt the encrypted broadcast; an encryptor to re-encrypt the broadcast decrypted by the decryptor using one or more re-encryption keys; and a storage unit to store the broadcast re-encrypted by the encryptor.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a cable broadcast system according to an embodiment of the present invention;

FIG. 2 is a detailed block diagram of a digital television (DTV) 200 shown in FIG. 1;

FIG. 3 is a flowchart explaining a process of re-encrypting a cable broadcast according to an embodiment of the present invention; and

FIG. 4 is a flowchart explaining a process of re-decrypting a cable broadcast and outputting the re-decrypted broadcast according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to like elements throughout. The embodiments are described below in order to explain the present invention by referring to the figures.

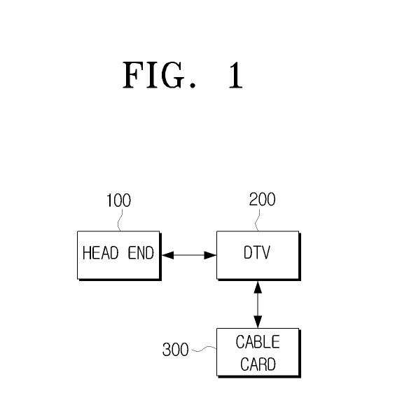

FIG. 1 is a block diagram of a cable broadcast system according to an embodiment of the present invention. Referring to FIG. 1, the cable broadcast includes a head end 100, a digital television (DTV) 200, and a cable card 300.

The head end 100 is a cable broadcast provider that provides a cable broadcast to the DTV 200 through a cable. The DTV 200 is a broadcast processing apparatus that performs signal processing on the cable broadcast received from the head end 100, and provides a user with the processed broadcast. The DTV 200 is connected to the cable card 300. The cable card 300 decrypts an encrypted cable broadcast received by the DTV 200. That is, cable broadcasts (particularly, charged cable broadcasts) are generally encrypted and input to the DTV 200.

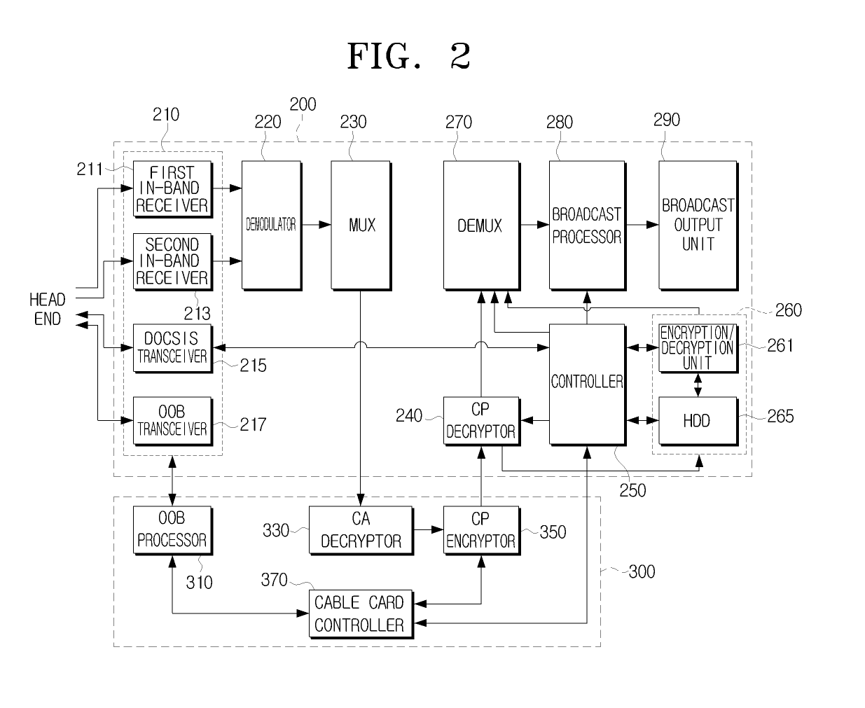

Hereinafter, the DTV 200 of FIG. 1 will be described in detail with reference to FIG. 2. FIG. 2 is a detailed block diagram of the DTV 200 shown in FIG. 1. In order to facilitate understanding of aspects of the present invention, FIG. 2 also illustrates the cable card 300.

Referring to FIG. 2, the DTV 200 includes a transceiver 210, a demodulator 220, a multiplexer (MUX) 230, a copy protection (CP) decryptor 240, a controller 250, a storage unit 260, a demultiplexer (DEMUX) 270, a broadcast processor 280, and a broadcast output unit 290.

The transceiver 210 includes a first in-band receiver 211, a second in-band receiver 213, a Data-Over-Cable Service Interface Specifications (DOCSIS) transceiver 215, and an Out-Of-Band (OOB) transceiver 217.

The first in-band receiver 211 and the second in-band receiver 213 tune a first cable broadcast and a second cable broadcast, respectively, from among a plurality of cable broadcasts received via a cable from the head end 100 (illustrated in FIG. 1), and transmit the tuned cable broadcasts to the demodulator 220. The received plurality of cable broadcasts includes cable broadcasts encrypted by a conditional access (CA)-encryption. CA-encryption is a technology used to allow only an authorized user to access a specific service among broadcast services provided by the head end 100. Although the first in-band receiver 211 and the second in-band receiver 213 tune the two cable broadcasts, as described above, it is understood that aspects of the present invention are not limited thereto. That is, according to other aspects, more than two in-band receivers may be included in the transceiver and, accordingly, more than two cable broadcasts can be tuned.

The DOCSIS transceiver 215 is connected to the head end 100 by a cable for bidirectional communication, so that data is transmitted and received between the DTV 200 and the head end 100. DOCSIS is a standard of cable modems certified by CableLabs, a United States cable system development consortium. The DOCSIS transceiver 215 performs bidirectional data communication, so that data received from the head end 100 may be transmitted to the controller 250 and data received from the controller 250 may be transmitted to the head end 100.

The OOB transceiver 217 transmits and/or receives electronic program guide (EPG) information and data service information to/from the head end 100 using a bandwidth other than a broadcast bandwidth. The OOB transceiver 217 may transmit data received from the head end 100 to the cable card 300, and/or may transmit data received from the cable card 300 to the head end 100. Specifically, the OOB transceiver 217 may transmit data received from the head end 100 to an OOB processor 310 of the cable card 300, or may receive data received from the OOB processor 310 of the cable card 300 and transmit the received data to the head end 100, so that it is possible to perform bidirectional data communication between the DTV 200 and the head end 100.

The OOB processor 310 performs signal processing with respect to the EPG information and/or data service information that the OOB transceiver 217 receives from the head end 100. Specifically, the OOB processor 310 performs signal processing so that the data service information may be transmitted to the head end 100 through the OOB transceiver 217.

A cable card controller 370 controls the entire operation of the cable card 300. In particular, the cable card controller 370 controls a processing operation of the OOB processor 310 of the cable card 300.

The demodulator 220 demodulates the cable broadcasts tuned by the first in-band receiver 211 and/or the second in-band receiver 213, and transfers the demodulated cable broadcasts to the MUX 230. According to other embodiments, the DTV 200 may include a first demodulator to demodulate the cable broadcast tuned by the first in-band receiver 211, and a second demodulator to demodulate the cable broadcast tuned by the second in-band receiver 213.

The MUX 230 multiplexes the demodulated cable broadcasts and transfers the multiplexed cable broadcasts to the cable card 300. The cable card 300 may CA-decrypt the CA-encrypted cable broadcasts transferred from the MUX 230. Specifically, a CA decryptor 330 of the cable card 300 may CA-decrypt the CA-encrypted cable broadcasts transmitted from the MUX 230. Here, a specific service of the cable broadcasts received from the head end 100 is CA-encrypted so that only an authorized user can access the service. Accordingly, the cable broadcasts are decrypted by the CA decryptor 330 of the cable card 300 in order to enable viewing. Generally, this specific service of the cable broadcasts is a broadcast service of charged channels. The CA decryptor 330 of the cable card 300 transmits the CA-decrypted cable broadcasts to a copy protection (CP) encryptor 350 in the cable card 300.

The CP encryptor 350 CP-encrypts the CA-decrypted cable broadcasts, and transfers the CP-encrypted cable broadcasts to the DTV 200. Here, the CP re-encryption prevents the cable broadcasts from being illegally copied by a user or a third party while the cable broadcasts are transferred to the DTV 200. In this situation, an unauthorized user or third party may directly extract the decrypted cable broadcasts from the cable card 300 to attempt to view the extracted broadcasts. However, the cable card 300 CP-encrypts the CA-decrypted cable broadcasts and transmits the CP-encrypted cable broadcasts to the DTV 200 to prevent such unauthorized viewing. The cable card controller 370 controls the entire operation of the cable card 300 as described above.

The CP encryptor 350 transmits the CP-encrypted cable broadcasts to the CP decryptor 240 of the DTV 200. Accordingly, the CP decryptor 240 receives the CP-encrypted cable broadcasts and decrypts the received cable broadcasts. Specifically, the CP decryptor 240 decrypts the CP-encrypted cable broadcasts using CP keys generated by the controller 250.

In order to generate CP keys, a mutual authentication process between the controller 250 and the cable card controller 370 may be performed. For example, the mutual authentication process checks whether the cable card 300 and the DTV 200 are registered (i.e., authorized) to receive cable broadcasts. The cable card 300 and the DTV 200 exchange authentication information with each other and determine whether the exchanged authentication information is valid. If it is determined that the authentication information is valid, the cable card controller 370 generates CP keys to encrypt the cable broadcasts, and the controller 250 of the DTV 200 generates CP keys to decrypt the encrypted cable broadcasts. According to other aspects, the controller 250 of the DTV 200 generates the CP keys to encrypt the cable broadcasts and the CP keys do decrypt the encrypted cable broadcasts. After the CP keys are generated, the cable card controller 370 transmits the generated CP keys to the CP encryptor 350. The CP encryptor 350 then encrypts the CA-decrypted cable broadcasts using the CP keys received from the cable card controller 370.

Additionally, the controller 250 of the DTV 200 transmits the generated CP keys to the CP decryptor 240, and the CP decryptor 240 decrypts the encrypted cable broadcasts using the CP keys received from the controller 250. In this situation, the cable card controller 370 may generate CP keys variably according to segments of the cable broadcast, and may transmit the generated CP keys to the CP encryptor 350. The controller 250 of the DTV 200 may also generate various CP keys according to segments of the cable broadcast and may transmit the generated CP keys to the CP decryptor 240.

The CP encryptor 350 may encrypt the cable broadcasts using CP keys updated at regular intervals in order to prevent the cable broadcast from being illegally copied and/or viewed by an unauthorized user or third party. Accordingly, the CP decryptor 240 may also decrypt the cable broadcasts using CP keys updated at regular intervals.

If a command to view a cable broadcast is received, the CP decryptor 240 transmits the decrypted cable broadcasts to the DEMUX 231. Alternatively, if a command to store a cable broadcast is received, the CP decryptor 240 transmits the decrypted cable broadcasts to the storage unit 260.

When in a viewing operation, the DEMUX 231 demultiplexes the decrypted cable broadcasts received from the CP decryptor 240 and transmits the demultiplexed cable broadcasts to the broadcast processor 280. The broadcast processor 280 performs signal processing (such as decoding) with respect to the demultiplexed cable broadcasts.

The broadcast output unit 290 selects a cable broadcast from among cable broadcasts output from the broadcast processor 280, and outputs a signal of the selected cable broadcast. In more detail, the broadcast output unit 290 may select one of a first cable broadcast and a second cable broadcast that are output from the broadcast processor 280, and may display the selected cable broadcast on a display (not shown). Alternatively, the broadcast output unit 290 may display the first cable broadcast and the second cable broadcast on a display (not shown) in a picture-in-picture (PIP) form so that one of the two cable broadcasts may be a main image and the other may be a sub-image.

The controller 250 controls the entire operation of the DTV 200. That is, the controller controls the broadcast receiving operation of the transceiver 210, the demodulating operation of the demodulator 220, the multiplexing operation of the MUX 230, the demultiplexing operation of the DEMUX 270, the scaling operation of the broadcast processor 280, and the cable broadcast outputting operation of the broadcast output unit 290. Additionally, the controller 250 generates CP keys to be used by the CP decryptor 240, and transmits the generated CP keys to the CP decryptor 240. Here, the controller 250 may update the CP keys at regular intervals and transfer the updated CP keys to the CP decryptor 240, as described above. Such CP keys may be updated variably according to broadcast segments. Furthermore, the controller 250 acquires CP key information regarding the CP keys updated at regular intervals, and stores the acquired information in a timestamp database (DB).

The CP key information includes information regarding the generated keys and broadcast segments re-encrypted using the generated keys. The timestamp DB is a memory in which the CP key information is stored using a predetermined program launched by the controller 250. Accordingly, the controller 250 may construct a database using the CP key information, when generating or updating CP keys and transmitting the CP keys to the CP decryptor 240.

The broadcast segments are portions of fixed duration into which the received cable broadcast is divided. For example, the controller 250 may generate a CP key “A” to be applied to a broadcast segment between time t0 and time t1, and the CP decryptor 240 may then decrypt a broadcast corresponding to the broadcast segment between time t0 and time t1 using the CP key “A” generated by the controller 250. Additionally, the controller 250 may generate a CP key “B” to be applied to a broadcast segment between time t1 and time t2, and the CP decryptor 240 may then decrypt a broadcast corresponding to the broadcast segment between time t1 and time t2 using the CP key “B” generated by the controller 250.

In this situation, the controller 250 may store in the timestamp DB information regarding the broadcast segments between time t0 and time t1 and between time t1 and time t2 in which the CP keys are updated and information regarding the CP keys are updated. Accordingly, the controller 250 may check which CP key is generated for which broadcast segment, and whether the cable broadcast is decrypted.

The controller 250 controls the decrypted cable broadcasts to be re-encrypted using the generated CP keys, and controls the re-encrypted broadcasts to be stored in the storage unit 260. The cable broadcasts stored in the storage unit 260 are updated at regular intervals, and re-encrypted using the CP keys (for example, generated variably according to the broadcast segments) so as to prevent illegal copying of the cable broadcasts even when the storage unit 260 is physically separated from the DTV 200.

If a command to output the re-encrypted and stored broadcasts is received, the controller 250 re-decrypts the cable broadcasts stored in the storage unit 260 using the CP key information included in the timestamp DB, and then transmits the re-decrypted broadcasts to the broadcast processor 280.

The storage unit 260 encrypts the broadcasts decrypted using the CP keys and stores the encrypted broadcasts. The storage unit 260 includes an encryption/decryption unit 261 and a hard disc drive (HDD) 265. The encryption/decryption unit 261 re-encrypts the cable broadcasts decrypted by the CP decryptor 240 using the CP keys. The HDD 265 stores cable broadcasts. In particular, the HDD 265 stores the broadcasts re-encrypted by the encryption/decryption unit 261.

If a command to output the cable broadcasts stored in the HDD 265 is received, the encryption/decryption unit 261 re-decrypts the re-encrypted cable broadcasts using the CP key information contained in the timestamp DB, and then transmits the re-decrypted cable broadcasts to the DEMUX 270.

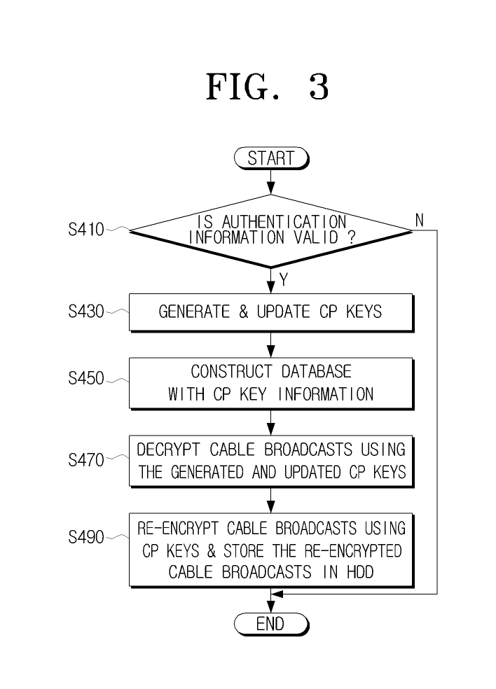

FIG. 3 is a flowchart explaining a process of re-encrypting a cable broadcast according to an embodiment of the present invention. Referring to FIGS. 2 and 3, the controller 250 determines whether authentication information transmitted between the controller 250 and the cable card controller 370 is valid by performing a mutual authentication process between the controller 250 and the cable card controller 370 in operation S410.

If it is determined that the authentication information is valid (operation S410), the controller 250 generates a plurality of CP keys and updates the generated CP keys at regular intervals in operation S430.

The controller 250 constructs a database using CP key information regarding the generated and updated CP keys in operation S450. Here, the CP key information, as described above, includes information regarding CP keys updated at regular intervals and information regarding broadcast segments in which the CP keys are updated.

The CP decryptor 240 decrypts the cable broadcasts encrypted by the CP encryptor 350 of the cable card 300 using the plurality of CP keys generated and updated by the controller 250 in operation S470.

Although operation S470 is performed after operation S450, it is understood that in other embodiments, operation S470 may be performed prior to operation S450, or operations S450 and S470 may be performed simultaneously.

Subsequently, the encryption/decryption unit 261 re-encrypts the cable broadcasts using the CP keys generated by the controller 250, and stores the re-encrypted cable broadcasts in the HDD 265 in operation S490.

Accordingly, the cable broadcasts are stored in the HDD 265 using the CP keys generated during the CP encrypting operation performed between the CP encryptor 350 of the cable card 300 and the CP decryptor 240 of the DTV 200, rather than using a separate encryption module. As a result, it is possible to prevent illegal copying of the cable broadcasts.

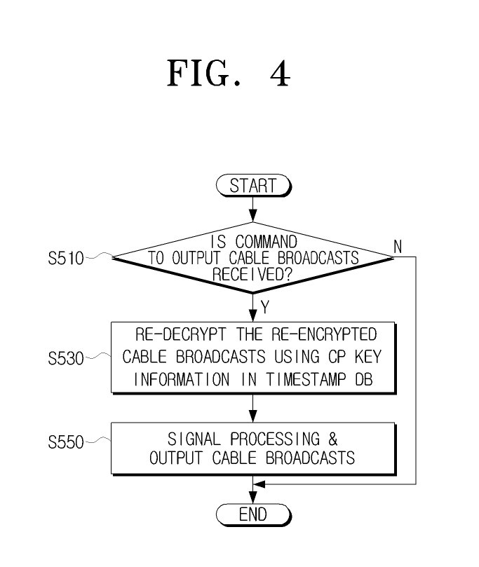

FIG. 4 is a flowchart explaining a process of re-decrypting cable broadcasts and outputting the re-decrypted broadcasts according to an embodiment of the present invention. Referring to FIGS. 2 and 4, the controller 250 determines whether a user inputs a command to output the cable broadcasts stored in the HDD 265 using a user input unit (not shown) in operation S510.

If it is determined that the user inputs the command to output the cable broadcasts stored in the HDD 265 (operation S510), the controller 250 re-decrypts the re-encrypted cable broadcasts using the CP key information included in the timestamp DB in operation S530.

Since the CP key information includes the information regarding CP keys updated at regular intervals and information regarding broadcast segments in which the CP keys are updated, the controller 250 may completely re-decrypt the cable broadcasts such that the cable broadcasts are identical to their form prior to re-encryption, using the same CP key as used for re-encryption in the same broadcast segment used for re-encryption.

After re-decryption of the cable broadcasts has finished, the controller 250 controls the broadcast processor 280 and broadcast output unit 290 to process the re-decrypted cable broadcasts and output the processed cable broadcasts in operation S550.

Although a cable DTV has been shown and described instead of a cable set-top box (STB) in the present embodiments, it is also possible to use only a STB instead of a DTV for re-encrypting and re-decrypting cable broadcasts.

Additionally, the encryption/decryption unit 261 of the storage unit 260 re-decrypts the cable broadcasts in the present embodiments, it is understood that aspects of the present invention are also applicable to a situation in which the CP decryptor 240 re-decrypts the cable broadcasts.

Furthermore, the timestamp DB has been described as a memory in which the CP key information is stored using a predetermined program launched by the controller 250, it is understood that the CP key information may also be stored in the HDD 265 in which the cable broadcasts are stored, so that there is no need for a separate memory.

As described above, according to aspects of the present invention, broadcasts are stored using CP keys in order to prevent broadcasts from being copied from the cable card, so that it is possible to preserve the security of broadcast content. Additionally, since certified CP keys are used, it is easier to manage the security of broadcast content. Finally, CP keys updated at regular intervals may be used so as to increase the security of broadcast content.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A broadcast processing apparatus receiving a broadcast encrypted by a cable card, the apparatus comprising:
a decryptor to decrypt the broadcast encrypted by the cable card;
an encryptor to re-encrypt the broadcast decrypted by the decryptor using one or more re-encryption keys;
a storage unit to store the broadcast re-encrypted by the encryptor; and
a controller to generate the one or more re-encryption keys, and to transmit the generated one or more re-encryption keys to the encryptor.

2. The apparatus as claimed in claim 1, wherein the controller generates a first re-encryption key for a first segment of the broadcast, and a second re-encryption key for a second segment of the broadcast.

3. The apparatus as claimed in claim 1, wherein the controller updates and varies the one or more re-encryption keys at regular time intervals.

4. The apparatus as claimed in claim 2, wherein the controller updates and varies the first re-encryption key and the second re-encryption key at regular time intervals.

5. The apparatus as claimed in claim 1, wherein the controller controls information regarding the broadcast and/or a segment thereof re-encrypted using the one or more re-encryption keys and information regarding the one or more re-encryption keys to be stored.

6. The apparatus as claimed in claim 5, wherein:
the decryptor re-decrypts the re-encrypted broadcast stored in the storage unit using one or more re-decryption keys; and
the controller generates the one or more re-decryption keys, and transmits the generated one or more re-decryption keys to the decryptor.

7. The apparatus as claimed in claim 2, wherein:
the decryptor re-decrypts the re-encrypted broadcast stored in the storage unit using a first re-decryption key and a second re-decryption key; and
the controller generates the first re-decryption key for the first segment of the broadcast, and the second re-decryption key for the second segment of the broadcast.

8. The apparatus as claimed in claim 6, wherein the controller generates the one or more re-decryption keys using the information regarding the broadcast and/or the segment thereof re-encrypted using the one or more re-encryption keys and the information regarding the one or more re-encryption keys.

9. The apparatus as claimed in claim 1, wherein the one or more re-encryption keys correspond to one or more encryption keys used by the cable card to encrypt the broadcast.

10. The apparatus as claimed in claim 9, wherein the one or more encryption keys and the one or more re-encryption keys implement copy protection (CP) encryption.

11. The apparatus as claimed in claim 1, wherein the broadcast comprises a cable broadcast.

12. A method of processing a broadcast encrypted by a cable card, the method comprising:
decrypting the broadcast encrypted by the cable card;
generating one or more re-encryption keys;
re-encrypting the decrypted broadcast using the generated one or more re-encryption keys; and
storing the re-encrypted broadcast.

13. The method as claimed in claim 12, wherein the generating of the one or more re-encryption keys comprises generating a first re-encryption key for a first segment of the broadcast, and a second re-encryption key for a second segment of the broadcast.

14. The method as claimed in claim 12, wherein the generating the re-encryption key comprises updating and varying the one or more re-encryption key at regular time intervals.

15. The method as claimed in claim 13, wherein the generating the re-encryption key further comprises updating and varying the first re-encryption key and the second re-encryption key at regular time intervals.

16. The method as claimed in claim 12, further comprising:
storing information regarding the broadcast and/or a segment thereof re-encrypted using the one or more re-encryption keys and information regarding the one or more re-encryption keys.

17. The method as claimed in claim 16, further comprising:
generating one or more re-decryption keys; and
re-decrypting the re-encrypted broadcast using the generated one or more re-decryption keys.

18. The method as claimed in claim 13, further comprising:
generating a first re-decryption key for the first segment of the broadcast, and a second re-decryption key for the second segment of the broadcast; and
re-decrypting the re-encrypted broadcast using the first re-decryption key and the second re-decryption key.

19. The method as claimed in claim 17, wherein the generating of the one or more re-decryption keys comprises generating the one or more re-decryption keys using the information regarding the broadcast and/or the segment thereof re-encrypted using the one or more re-encryption keys and the information regarding the one or more re-encryption keys.

20. The method as claimed in claim 12, wherein the one or more re-encryption keys correspond to one or more encryption keys used by the cable card to encrypt the broadcast.

21. The method as claimed in claim 20, wherein the one or more encryption keys and the one or more re-encryption keys implement copy protection (CP) encryption.

22. The method as claimed in claim 12, wherein the broadcast comprises a cable broadcast.

23. A computer readable recording medium encoded with the method of claim 12 and implemented by a computer.

24. A broadcast processing system receiving a broadcast, the system comprising:
a cable card to encrypt the broadcast using one or more encryption keys; and
a broadcast processing apparatus comprising:
a decryptor to decrypt the encrypted broadcast using one or more decryption keys,
an encryptor to re-encrypt the broadcast decrypted by the decryptor using one or more re-encryption keys, and
a storage unit to store the broadcast re-encrypted by the encryptor.

25. The system as claimed in claim 24, wherein:
the cable card comprises:
a controller to generate the one or more encryption keys if a mutual authentication between the cable card and the broadcast processing apparatus is successful, and
an encryptor to encrypt the broadcast after the controller generates the one or more encryption keys; and
the broadcast processing apparatus comprises:
a controller to generate the one or more decryption keys if the mutual authentication between the cable card and the broadcast processing apparatus is successful.

26. The system as claimed in claim 24, wherein the one or more encryption keys correspond to the one or more re-encryption keys.

27. The system as claimed in claim 24, wherein:
the cable card comprises a decryptor to decrypt the broadcast using one or more first decryption keys before the cable card encrypts the broadcast using the one or more encryption keys, and
the one or more first decryption keys implement a first decryption method, the one or more encryption keys and the one or more re-encryption keys implement an encryption method, and the one or more decryption keys implement a second decryption method different from the first decryption method and corresponding to the encryption method.

28. The system as claimed in claim 24, wherein the encryption method is a copy protection encryption, and the second decryption method is a copy protection decryption.

29. The system as claimed in claim 24, wherein:
the one or more encryption keys comprise a first encryption key for a first segment of the broadcast, and a second encryption key for a second segment of the broadcast; and
the one or more re-encryption keys comprise a first re-encryption key for the first segment of the broadcast, and a second re-encryption key for the second segment of the broadcast.

30. The system as claimed in claim 24, wherein the one or more encryption keys and the one or more re-encryption keys are updated and varied at regular time intervals.

31. The system as claimed in claim 24, wherein the broadcast processing apparatus comprises a controller to control information regarding the broadcast and/or a segment thereof re-encrypted using the one or more re-encryption keys and information regarding the one or more re-encryption keys to be stored.

32. A method of processing a broadcast, the method comprising:
encrypting the broadcast using one or more encryption keys in a cable card;
transmitting the encrypting broadcast from the cable card to a broadcast storage apparatus;
decrypting the encrypted broadcasting using one or more decryption keys in the broadcast storage apparatus;
re-encrypting the decrypted broadcast using one or more re-encryption keys in the broadcast storage apparatus; and
storing the re-encrypted broadcast in the broadcast storage apparatus.

33. A broadcast processing apparatus receiving an encrypted broadcast, the apparatus comprising:
a decryptor to decrypt the encrypted broadcast;
an encryptor to re-encrypt the broadcast decrypted by the decryptor using one or more re-encryption keys; and
a storage unit to store the broadcast re-encrypted by the encryptor.
